(19) United States
(12) Patent Application Publication
(10) Pub. No.: US 2024/0278107 A1
(43) Pub. Date: Aug. 22, 2024

(54) 1 v 1 SCORING SYSTEM USING NFC TECHNOLOGY

(71) Applicant: THE 1V1 FORMULA TOURNAMENT, Franklin, TN (US)

(72) Inventor: Stephen Andrew Guppy, Franklin, TN (US)

(21) Appl. No.: 18/408,361

(22) Filed: Jan. 9, 2024

Related U.S. Application Data
(60) Provisional application No. 63/447,239, filed on Feb. 21, 2023.

(51) Int. Cl. A63B 71/06; G06K 19/07; H04B 5/77

(52) U.S. Cl. CPC A63B 71/0669; G06K 19/0723; H04B 5/77

(57) ABSTRACT

Traditional 1 v 1 athletic contests required too much time for the judges to track points. This results in a slow transition between rounds, errors in scores, and lots of paperwork for judges. By incorporating the 1v1 scoring system of the present invention applying NFC technology, athletes maximize transition between rounds, judges can keep track of points quickly and accurately, and weather does not affect point tracking because everything is kept digitally.

### CROSS REFERENCE TO RELATED APPLICATIONS

The present application claims priority to U.S. Provisional Patent Application Ser. No. 63/447,239 filed on Feb. 21, 2023, the contents of which are incorporated herein by reference.

### FIELD OF INVENTION

The present invention relates to a scoring system used in 1 v 1 sports events by near field communication (NFC) technology. The NFC technology for the scoring system includes NFC tags, an NFC reader, and a mobile app.

### BACKGROUND OF THE INVENTION

The 1 v 1 athletic events split players in pairs, where the competition is conducted between two players in the pair. Such 1 v 1 competition events are often carried out in an athletic training program. The 1 v 1 athletic event applies to (but not limited to) soccer, basketball, lacrosse, American football, rugby, Australian rules football, cricket, and baseball. During a 1 v 1 athletic event, judges must keep track of the score and players. Judges can mistakenly give points to the wrong player or write down the wrong number of points.

Using paper to keep track of points and players is not efficient. Current applications require the person to go through entire list of players to determine which two participants are competing.

NFC using the NFC tags, the NFC reader, and the mobile app eliminate errors in scoring/player identification. It is also weather resistance due to the nature of the technology.

### SUMMARY OF THE INVENTION

One objective of the present invention is to provide a scoring system for 1 v 1 competition events using NFC technology. The scoring system records and displays scores of the players participating in the 1 v 1 sporting event. The system comprises a plurality of NFC tags, an NFC reader connected to a device, such as a computer, and a mobile app installed in the device. Each of the NFC tags, which is embedded in an NFC tag carrier and set at read only mode, contains a unique identification (ID) configuration to be assigned to one of the players participating in the 1 v 1 competition event. During the event, the NFC tag carrier is attached to body of the player. The NFC reader is compatible with the NFC tags so that the NFC tags are scannable with the NFC reader to transmit the ID from the NFC tag to the mobile app in the device through the NFC reader.

The mobile app is configured to perform following operations. The operations include registering the players with their IDs of the NFC tags, recording the player's name, the ID, and a score total for each of the players, receiving ID of a winning player from the NFC reader during a round of the competition event, looking up the winning player name based on the received ID, prompting a judge to enter a score point for the winning player, adding the point to the score total of the winning player, and displaying the score totals of the players in a monitor screen of the device. The app will also send this data to the “cloud” database for storage and use on the website to report scores on the public facing website.

Another objective of the present invention is to provide a method of scoring for 1 v 1 competition events using NFC technology. During the 1 v 1 sporting competition, the assigned NFC tag is attached to body of the player, for example, a bracelet embedded with the NFC tag is worn by the player. When a player has won in a round of the game, the player scans the NFC tag with the NFC reader, which transmits the ID information of the player from the NFC reader to the mobile app in the device. The mobile app receives the ID from the NFC reader, looks up the winning player based on the ID, prompts a judge to enter a score point for the winning player, adds the score point to the score total of the player, and display the score totals of the players in the monitor screen of the device.

### BRIEF DESCRIPTION OF THE DRAWINGS

FIG. 1 depicts a pair of players in a 1 v 1 sporting competition event.

FIG. 2A depicts a bracelet embedded with an NFC tag worn by a player.

FIG. 2B depicts an NFC reader.

FIG. 2C demonstrates a game score of two players, shown in a monitor screen of the device.

### DETAILED DESCRIPTION

The illustrations of the drawings are for the purpose of describing selected versions of the present invention and are not intended to limit the scope of the present invention.

During a 1 v 1 athletic event, judges must keep track of the score and players. The judge can mistakenly give points to the wrong player or write down the wrong number of points. The present invention solves this problem.

The present invention differs from what currently exists. It is an improvement of the currently scoring method for 1 v 1 competition events. Presently, judges must keep player on paper or constantly figuring out the next players to play. This is particularly difficult when multiple pairs of players are playing simultaneously in the event. Additionally, the current scoring systems take too long to progress through the 1 v 1 games. They also can fail in adverse conditions, such as raining or snowing. NFC technology eliminates errors in scoring/identification. It is weather resistant due to the nature of the technology. Therefore, NFC technology used in 1 v 1 competitions revolutionizes how score points/players can be tracked.

The scoring system of the present invention combines NFC tags, readers, hardware, and mobile app to collect points in 1 v 1 athletic events. Each of the players in the event have an NFC tag on their person. This could be a wearable NFC bracelet made by embedding the NFC tag into the bracelet or an NFC card by embedding the NFC tag into the card (if player is allergic to silicone.) Based on rules of the event, the winner would scan the NFC tag on an NFC reader which is connected (wired or wirelessly) to a mobile device or computer installed with a mobile app that prompts the judge/coach to select a point total for the round. That data is then sent to a central server to update the players score, scoreboard, etc. Sports using this scoring system apply to (but not limited to) Soccer, Basketball, Lacrosse, American Football, Rugby, Australian Rules Football, Cricket, and Baseball.

By using NFC technology, the judge only has to confirm the points for each round. The judge does not have to keep track of the players or the score totals, which is all done by the NFC tags, the NFC reader, and the mobile app.

The NFC used for 1 v 1 scoring system comprises three parts, including an NFC tag inserted into an NFC bracelet or a card, an NFC reader connected to a computer or a mobile device, and a mobile app installed in the computer or the mobile device. The computer will receive the identification (ID) input from the NFC tag through the NFC reader. The most necessary elements are NFC tags and NFC reader. The NFC tag worn on the player's body carries player's ID while the NFC reader is available to scan the tag to register the score totals of the player.

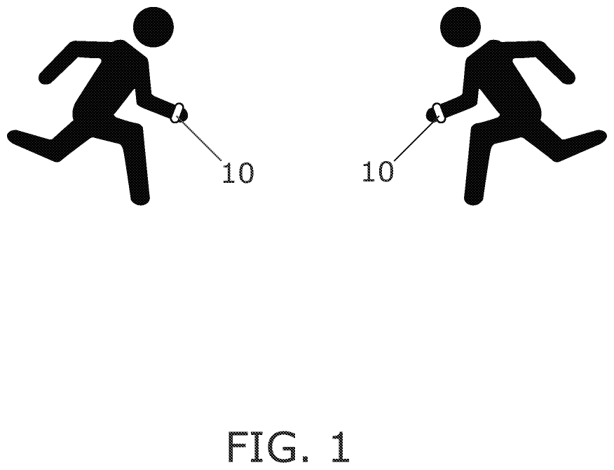

Referring to FIG. 1, there depicted is a pair of two players in a 1 v 1 sporting competition event according to one embodiment. Each of the two players wears an NFC bracelet 10 on the wrist. As shown, the 1 v 1 competition event refer to a competition between two players in a pair although there might be multiple pairs competing simultaneously in a competition event.

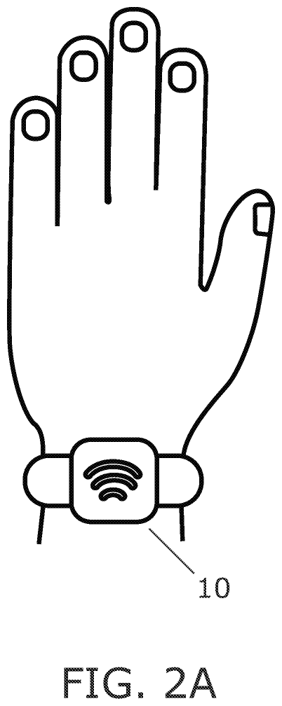

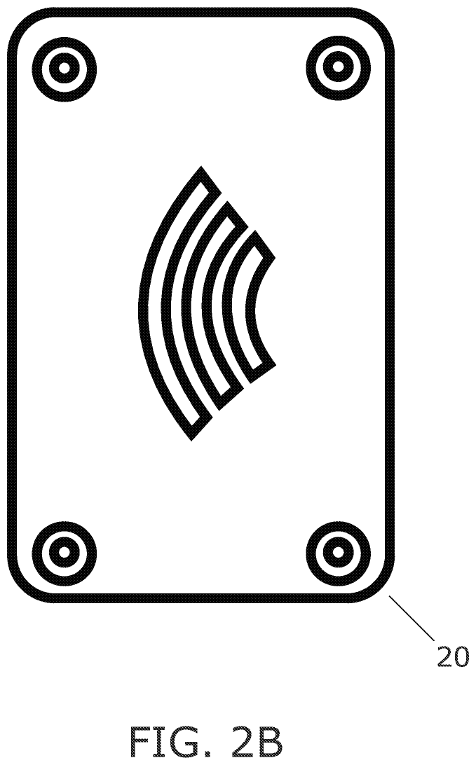

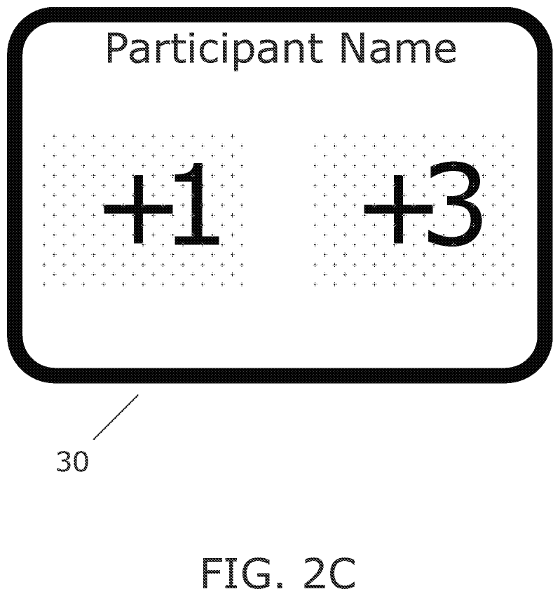

Referring to FIG. 2A, there depicted is an NFC bracelet 10 worn in the wrist of a player. The NFC tag comprises an integrated circuit (IC) chip that can be categorized into four types, providing different communication speeds and capabilities. NFC tags are typically read-only but may be writable. When used in a 1 v 1 scoring system, NFC tags are set in read only mode whether NFC tag is read only or writable. Preferably, NFC tags are selected from Type 2 ISO read only.

Referring to FIG. 2B, there depicted is an NFC reader 20, where a scanning sign is shown in the screen monitor of the reader. The NFC reader is used to receive information from NFC tag wirelessly by scanning in a close range. When connected with a computer or a mobile device either by electrical wiring or wirelessly, the NFC reader transmits the information received from NFC tag to the computer or the mobile device.

Referring to FIG. 2C, there depicted are game scores 30 of two players shown in a monitor screen of the device installed with the mobile app according to the embodiment. The app can be installed in a computer, a mobile device, or a smartphone. During the 1 v 1 competition, the mobile app is configured to pull ID from the NFC reader, look up player, and prompt judge to enter score. The app interface will provide possible scores, making it easy for the judge to select. The app will also be able to update demographics for individual and assign new bracelet to a player. If a bracelet is damaged/lost the judge will need to be able to assign a new bracelet quickly to a player. The app will also upload stats for 1v1 games to cloud server. This will allow the public to see those results, and track progress of individual players.

The mechanism of applying NFC technology in 1 v 1 competition scoring is simple and straight forward for the user to understand. During a 1 v 1 sporting competition, after a winner has been determined to have won in a game round, the NFC bracelet or card of the winner is put near NFC reader to transmit the information stored in NFC tag to the mobile app through the NFC reader. The mobile app then uses the ID information of the player to prompt the user to enter a score point and to confirm points for the user.

A procedure of using NFC technology for 1 v 1 competition scoring is as follows. Firstly, the NFC bracelets are put on the wrists of the players, or the NFC cards are carried by the players (if the player is not able to wear a bracelet due to allergy to silicon/rubber). When the two players compete in a 1 v 1 athletic event and a winner is determined, the winner goes over to the NFC reader and scans his NFC bracelet or card on the reader. The reader then sends this information to the computer or the mobile device. The computer uses the mobile app to display the name of the player and display possible points for the judge to select.

A preparation procedure for a 1 v 1 competition scoring using NFC technology includes following steps: 1) obtain an NFC bracelet/card and a compatible NFC reader; 2) configure the computer or a mobile device to communicate with the NFC reader; 3) develop a mobile app for receiving, looking up the IDs received from the NFC reader, displaying the name of the player, and as an option assigning points to the player. All above elemental steps are necessary. A person could use a smart watch to communicate with the computer, bypassing the need for an NFC reader to provide identification and points of the player.

If a user organizes a 1 v 1 sporting competition event where multiple pairs of players are competing, the user can use the present invention to keep track of players, score points of each round, and score totals. The user would have the players put on the bracelets. After each round, the winners are told to come over to the scoring table to scan their bracelets. A prompt will pop up on the screen confirming the player's name and how many points that the user wants to give the player. The user taps the screen and confirm the total score for the player.

In additional to the sporting events, the 1 v 1 scoring system using NFC technology of the present invention could be used for public speaking contests, mathematics, or other education contests between opponents. For any contest where two people compete and there is a clear winner of the round, this technology can be used in scoring.

Although the invention has been explained in relation to its preferred embodiment, it is to be understood that many other possible modifications and variations can be made without departing from the spirit and scope of the invention.

What is claimed is:

1. A scoring system for 1 v 1 competition events using NFC technology, the system comprising:
a plurality of NFC tags set at read only mode, wherein the NFC tag is embedded in an NFC tag carrier, each of the NFC tags contains a unique ID configuration, each one of multiple players participating in the 1 v 1 competition event is assigned by one of the NFC tags, and the NFC tag carrier is attached to body of the player during the event,
an NFC reader connected to a device, the NFC reader being compatible with the NFC tags so that the NFC tags are scannable with the NFC reader to transmit the ID from the NFC tag to a mobile app installed in the device through the NFC reader, and
the mobile app configured to perform operations including:
to register each of the players with the ID of the NFC tag assigned to the player,
to record the player's name, the ID, and a score total for each of the players,
to communicate with the NFC reader for receiving ID of a winning player during a round of the competition event,
to look up the winning player name based on the received ID,
to prompt a judge to enter a score point for the winning player,
to add the point to the score total of the winning player, and
to display the score totals of the players in a monitor screen of the device.

2. The system of claim 1, wherein the NFC tag carrier is selected from a group including bracelet and card.

3. The system of claim 1, wherein the mobile app is further configured to perform one or more tasks, the tasks including:
updating demographics for the players participating in the 1v1 competition event,
uploading stats of the 1v1 competition event to a cloud server so that public is allowed to view result of the event, and
registering a new NFC tag to a player when the previous NFC tag assigned for the player is damaged.

4. The system of claim 1, wherein the device is selected from a group including a computer, an iPad, and a smartphone.

5. The system of claim 1, wherein the mobile app is configured to record personal information of each of the players.

6. The system of claim 1, wherein the NFC reader is connected to the device either by electrical wiring or wirelessly.

7. The system of claim 1, wherein the 1 v 1 competition events comprise sporting contests selected from a group including soccer, basketball, lacrosse, American football, rugby, Australian rules football, cricket, and baseball.

8. The system of claim 1, wherein the 1 v 1 competition events further comprise education contests including mathematic contests and public speaking contests.

9. The system of claim 1, wherein the 1 v 1 competition events include multiple pairs of players playing simultaneously at the event.

10. A method of scoring at 1 v 1 competition events using the scoring system claimed in claim 1, the method comprising steps of:
providing a plurality of NFC tags set at read only mode, wherein each of the NFC tags contains a unique ID configuration and the NFC tag is embedded in a NFC tag carrier,
providing an NFC reader connected to a device, the NFC reader being compatible with the NFC tags,
providing a mobile app installed in the device, the mobile app configured to record the ID, the player, and score total for each of the players,
assigning one of the NFC tags to each one of the players,
attaching the carrier of the assigned NFC tag to body of the player,
registering each of the players with the corresponding ID in the mobile app,
scanning the NFC tag of the player with the NFC reader after the player winning a score point in a round of the event to transmit the ID of the NFC tag to the mobile app,
looking up the winning player name in the mobile app based on the ID,
prompting a judge to enter a score point for the winning player in the mobile app,
adding the point to the score total of the winning player by the mobile app, and
displaying the scores of the players in a monitor screen of the device.

11. The method of claim 10, wherein the NFC tag carrier selected from a group including bracelet and card.

12. The method of claim 10, wherein the device is selected from a group including a computer, an iPad, and a smartphone.

13. The method of claim 10, wherein the mobile app is further characterized to perform one or more tasks, the tasks including:
updating demographics for the players participating in the 1v1 competition event,
uploading stats of the 1v1 games to a cloud server so that public is allowed to view result of the contest, and
registering a new NFC tag to a player when the previous NFC tag assigned to the player is damaged.
